(19) United States
(12) Patent Application Publication
(10) Pub. No.: US 2004/0031027 A1
(43) Pub. Date: Feb. 12, 2004

(54) System for updating diverse file versions

(76) Inventor: Daniel K. Hiltgen, Los Gatos, CA (US)

Correspondence Address: HOWREY SIMON ARNOLD & WHITE, LLP, BOX 34, 301 RAVENSWOOD AVE., MENLO PARK, CA, 94025, US

(21) Appl. No.: 10/215,545

(22) Filed: Aug. 8, 2002

(51) Int. Cl. G06F 9/44

(52) U.S. Cl. 717/170

(57) ABSTRACT

An update system for updating different versions of an original source file that have been generated in different workspaces is implemented in a network of processor-based systems. A first modified version and a second modified version of the source file are stored in the network. First and second change sets, respectively, are generated, representing the net deltas in the first and second modified versions of the source file. The modifications of the first modified version can then be applied to the second modified version by comparing the corresponding modified regions, and applying modifications only to those regions in the target (i.e. second) file that have not been modified relative to the original source file, thus preserving any modifications in the target file which were not present in the first modified version. If target code has moved, its new position is located by a comparison procedure, and modifications are then made.

### BACKGROUND OF THE INVENTION

The present invention relates to a system for applying modifications to one version of a given source file, such as an application or an operating system, to another version of the same file, even when the two versions of the file may have diverged due to different update histories.

In UNIX applications, or versions of the UNIX operating system, a source management system known as the Source Code Control System (SCCS) is used to keep track of a source file's development, and to prevent it from being modified by more than one person at a time. In particular, it provides a mechanism for keeping track of each revision (or version) of a given document, i.e. source file.

With SCCS, a series of “deltas” (files reflecting the changes from one version to the next) is created, and these are stored as part of the “s-file”, which is a single file that contains all the different versions of the source file. Each delta represents the differences between the version that a user got for editing and the version after that user applied his or her edits. All of the different versions of the file are stored in the s-file, which thus represents the entire history of changes to the original file.

Using the conventional SCCS approach, when a user wants to update a given file, he must first make sure that the file is has the correct modification history. For instance, if a source file has been modified separately in a first workspace and a second workspace, the separately modified versions must be synchronized to incorporate all changes, which may involve incorporating changes from one workspace into the other, often by manual coding, which is very labor-intensive and can easily lead to errors.

Accordingly, a system is needed in which updates to diverging versions of a source file can be imported from one to the other in an automatic fashion. In particular, such a system is needed wherein, when multiple versions of a file have evolved, modifications can be applied from one file to another without first providing the two files with the same revision history.

### SUMMARY OF THE INVENTION

An apparatus and method according to one embodiment of the present invention are implemented in a network setting, in particular where two or more gates or workspaces are used by engineers to modify source files. A first engineer using a first workspace brings a source file over to make modifications or updates to it, and a second engineer at a second workspace brings the same a source file over to make different modifications. This generates first and second versions, respectively, of the source file. To apply the first engineer's modifications to the second version of the source file, the regions in the original source file that were modified in the first modified version are compared with the corresponding regions in the second version, and if the second version does not include changes to those regions relative to the original source file, then the modifications from the first modified version are applied. For any regions in the second version where the second engineer has made changes to the original source file, the modifications from the first modified version are not applied. The reverse procedure can also be followed, to apply changes made in the second modified version of the source file to the first modified version of the source file.

The changes can be applied from one modified version of the source file to another by generating “deltas”, i.e. concatenated, net change sets of a given modified version of the source file with respect to the original source file. Each modified version of the source file thus has its own change set or delta, and that change set can be applied to any other modified versions of the source file, either entirely or in part, depending on whether corresponding regions of the target version of the source file have been modified.

The change sets of differently modified versions of the source file are applied to one another without regard to any other aspects of the modification histories of the respective modified source files. In particular, the version numbers and modification histories of the different versions of the source files are ignored, with only the final deltas of the modified versions over the original version of the source file being taken into account. Diverging versions of the source file thus receive the benefit of updates, bug fixes and other modifications without manual coding or a requirement that the divergent versions be synchronized with one another.

### BRIEF DESCRIPTION OF THE DRAWINGS

FIG. 1 is a block diagram of a conventional network suitable for an implementation of the present invention.

FIG. 2 is a block diagram illustrating multiple gates in which users may modify source files.

FIG. 3 is a table showing an example of divergent code modification.

FIG. 4 is a flow chart illustrating an embodiment of a method according to the invention.

### DESCRIPTION OF THE PREFERRED EMBODIMENTS

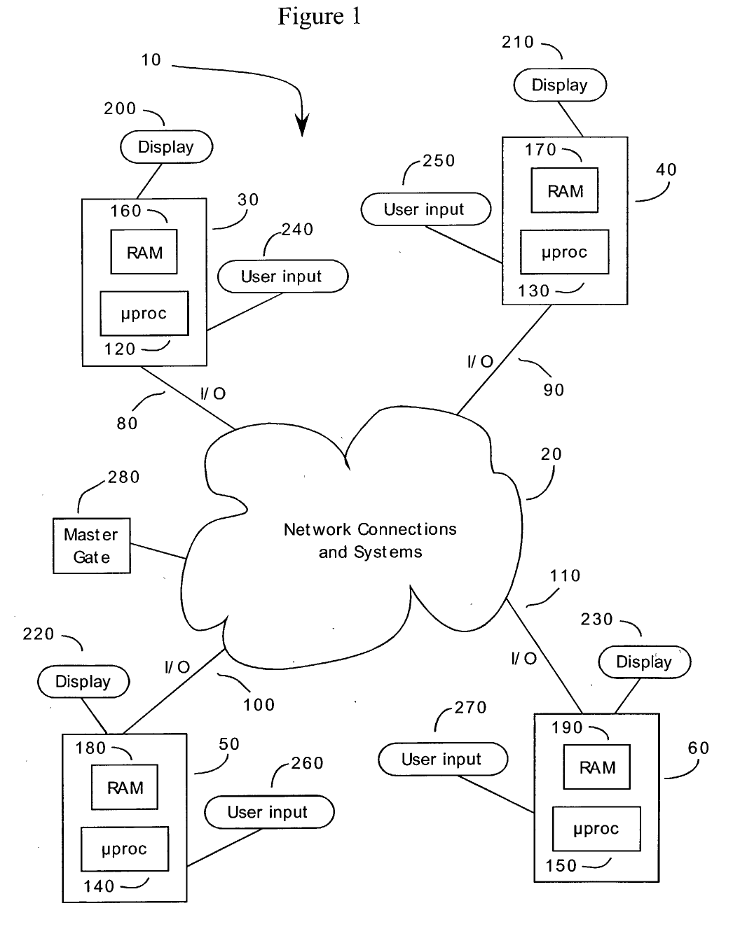

FIG. 1 shows a conventional network including systems and connections 20, which may be any of a variety of types of networks, such as a local area network (LAN), a wide-area network (WAN), or other intranets or the Internet. Conventional processor-based systems such as workstations 30-60 are connected via I/O connections 80-110.

Each system 30-60 includes, as shown, at least one microprocessor such as microprocessors 120-150, respectively, which execute instructions according to code or program modules stored in their respective RAM (read-only memory) components 160-190. Displays 200-230 and user input devices (including keyboards, mice, track balls, etc.) 240-270 are also provided.

A master gate 280 is accessible via the network 10. As used herein, a gate is a workspace from which a user can get the code constituting a source file, such as an operating system or an application, in order to modify that file and put it back into the gate. Typically, a gate will have a gatekeeper, namely a person who controls the code that is put back into the gate. Thus, the gate may be a full set of files or a subset of files relating to an operating system, an application, or any other code or documents that a user may wish to work with, and typically would include files that are modified using teamware, i.e. software used to modify files by a group of engineers in different workspaces.

Systems 30-60 may thus be any conventional processor-based systems on which users can modify such files and communicate with the gate 280.

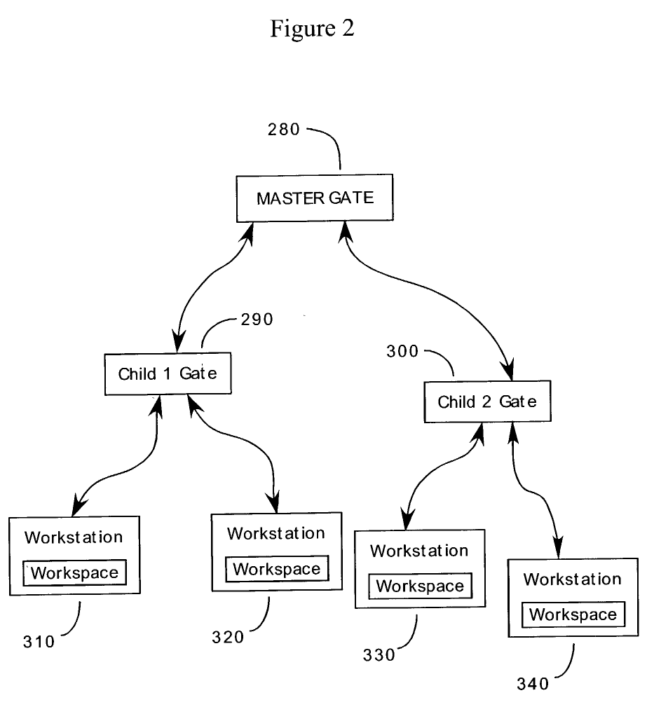

FIG. 2 shows a logical hierarchy of the master gate 280 with child gates 290-300. Each child gate in this example is itself a workspace at which one or multiple users can, from their workstations 310-340, modify code originally obtained from the master gate 280.

Two typical operations with respect to a gate or workspace are bringover and putback operations. A user will bring a copy of the gate (or workspace) over, make changes locally, and then put the modified file back, subject to the gatekeeper's approval. Note that copying a gate or a workspace is used herein to meant copying whatever file is in that workspace, e.g. the s-file of a document that the user wants to work on. A user may bring over one or multiple files.

These types of teamware operations are usable in the present invention. The hierarchy of FIG. 2 may be extended as needed, so that there is a single master gate and multiple levels of child gates, if desired.

In the example of FIG. 2, the child 1 gate (290) might, for instance, be used by an engineer to make modifications to applicant's Solaris™ operating system (OS), Version 8, while the child 2 gate (300) is used by other engineers to make modifications to the Solaris™ OS, Version 9. The SCCS histories of these to OS versions would in this example be divergent, though the original source file would have been the same at the master gate 280.

In this example, the engineer at gate 290 may be making a bug fix in the OS Version 8, and thus a given version (e.g. version 1.1) of the file at gate 290 may reflect that bug fix. At the same time, version 1.1 of the file at gate 300 may reflect a feature enhancement added to Version 9 of the OS.

In this situation, in general the lines modified at gate 290 and those modified at gate 300 will be in different portions of the code, and it would be desirable to port the bug fix over to Version 9 of the code at gate 300. Similarly, if a bug is fixed in Version 9 of the OS at gate 300, it is desirable to backport this fix to Version 8, which is not feasible using the standard SCCS approach, because of the need to synchronize the entire OS file with all of its deltas.

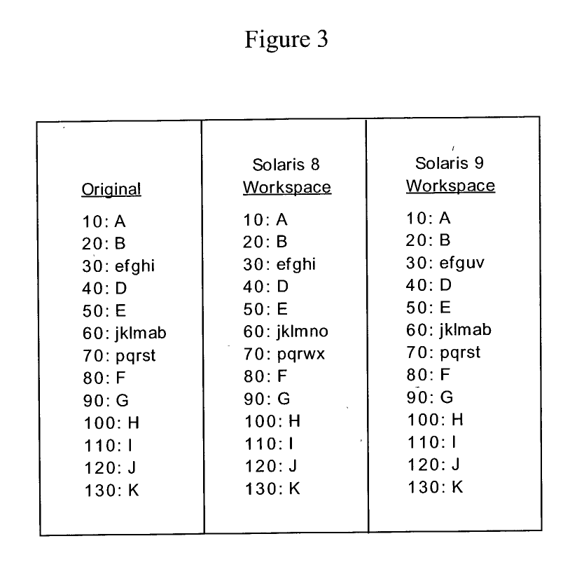

FIG. 3 shows a table illustrating this example. The original code (which may be in any programming language, e.g. C++, applicant's Java™ language, etc.), and the line numbers 10-130 are examples of identifying line numbers for any such language. In this example, an engineer brings the file over to the Solaris™ 8 workspace (or gate), and modifies, for example, lines 60-70 as indicated. (Note that the indications A, B, jklmab, etc. are placeholders for any blocks of actual code.) At the same time, another engineer brings the original file over to the Solaris™ 9 workspace, and modifies line 30 as shown.

FIG. 5 is a flow chart illustrating a procedure according to the invention that can be followed in such a situation. Typically, this procedure is carried out by program code or modules executed on a workstation or server on the network 10 shown in FIG. 1. Thus, any of the steps carried out according to a method of the invention may be implemented in suitable logic—i.e., stored and executed as appropriate software in conjunction with firmware or hardware, as appropriate.

The two bringover operations mentioned above take place at step 410, and the modifications are indicated at step 420. When the engineer (here “user 2”) for the Solaris™ 9 workspace is finished with his modification, he puts the modified file back into the master gate 280 and/or stores it in his own workspace (or gate), with line 30 (in the example of FIG. 3) altered, as indicated at step 430.

At step 440, user 1 (i.e. the engineer working on the Solaris™ Version 8 OS) begins the process of updating the now-modified file at the master gate with the changes to lines 60-70. The aim in this example is to incorporate only those changes to lines 60-70, without affecting the rest of the file as stored by user 2. Note that the conventional SCCS delta versioning approach fails in this case, because respective version numbers of user 1's and user 2's modified version of the OS (or other file) do not match up.

At step 450, all of the deltas that may have been generated in user 1 's workspace are concatenated, generating a single change set representing all of the modifications over the source file. For instance, if there are four deltas to be applied to the source file, this is done—typically one after the other, though in certain circumstances it is contemplated that an effectively simultaneous modification process could be carried out, particularly where the deltas affect nonoverlapping portions of code. The resulting change set will be applied to other versions of the file that may exist in the master gate or in other workspaces.

At step 460, the lines that have been modified in user 1's workspace are compared with the target file—e.g., the file as modified and stored in user 2's workspace. It is first determined whether the target lines of codes have been modified since user 1 obtained them. Thus, lines 60-70 of the original file are compared with the corresponding lines of the Solaris™ 9 workspace code in gate 300 (see FIG. 2). In the example shown in FIG. 3, these lines of code have not changed in the Solaris™ 9 code, and thus are suitable for modification according to user 1's changes.

It is possible that the line numbers themselves have changed due to user 2's modifications (even though the code itself has not been altered), such that lines 60-70 now come out on different lines due to addition or deletions of lines of code elsewhere in the file. The UNIX operating system's “diff” command, or the equivalent, can be used in a contextual operation to locate such moved lines of code, by comparing lines before and after within a predetermined range of lines (e.g., +/−5 lines of code). Thus, if lines 60-70 have been moved, then the contextual diff command can compare the original lines with the moved lines, within the predetermined range, and locate the new position of the lines, and then carry out the compare operation as needed. Other contextual comparisons may be implemented besides the UNIX diff procedure and will be suitable for the present invention, with the common requirement being that the original file's lines are compared with the target file's lines to determine that the block of code desired to be updated has not been otherwise altered (and to determine the code block's new position, if any).

At step 470, if the compared lines are similar (even if their line numbers or positions within the file have changed), then the method proceeds to step 500, where user 1's modifications are applied to the code. In a conventional UNIX setting, this can be done using the “patch” command, and in general the operation involves incorporating the code as modified by user 1 in place of the corresponding code in the single modified file.

If similar blocks of code appear at different locations within the file, it is possible that the update procedure could replace the wrong block of code. To prevent this, the patch command (or other operation) can begin by looking for the block of code at the expected location, and then move up and down from that location within a predefined proximity. If the predefined proximity is exceeded, then a rejection of the update is issued, or user feedback can be solicited by the code, so that the user can input a code block selection to override the rejection.

It is possible that user 2 will have made changes to the same block of code that was changed by user 1. For example, in the comparison operation of step 460, it might be determined that line 60 in the Solaris™ 9 workspace now reads “jklmyz” instead of the original “jkhnab”, in which case incorporating user 1's “jklmno” update may corrupt or otherwise defeat the purpose of user 2's modifications. In this case, at step 480 the update is rejected, and at step 490, an alternative update procedure is executed.

Such an alternative update procedure may include manual coding to incorporate user 1's changes, or some other operation that takes into account the alterations to the target code.

After either step 490 or step 500, if there are additional changes to be made to the code (step 510), the method can proceed to step 410 for additional bringover operations.

Generating a change set as at step 450 allows an engineer to apply user 1 's modifications to any version of the document or file in question, regardless of how different the modification history of the target file may be from user 1 's version of the file. The contextual comparison step 460 allows version numbers and delta files to be bypassed, and instead provides a direct patch of the change set to the target file.

The change set may be applied to the original source file in the master gate 280, or to any version of that file as modified in other workspaces, as desired. This allows patches and feature enhancements to be selectively applied to other versions of a given OS, application or other file, without requiring that such other files have corresponding modification histories with respect to the file that produced the change set. Accordingly, a bug fix in a later version (e.g. Solaris™ OS Version 9) can be applied to an earlier version (e.g. Version 8) (or vice versa), where the two versions will in general have widely divergent update histories, and where it may not even be desirable that the two versions ever be fully synchronized.

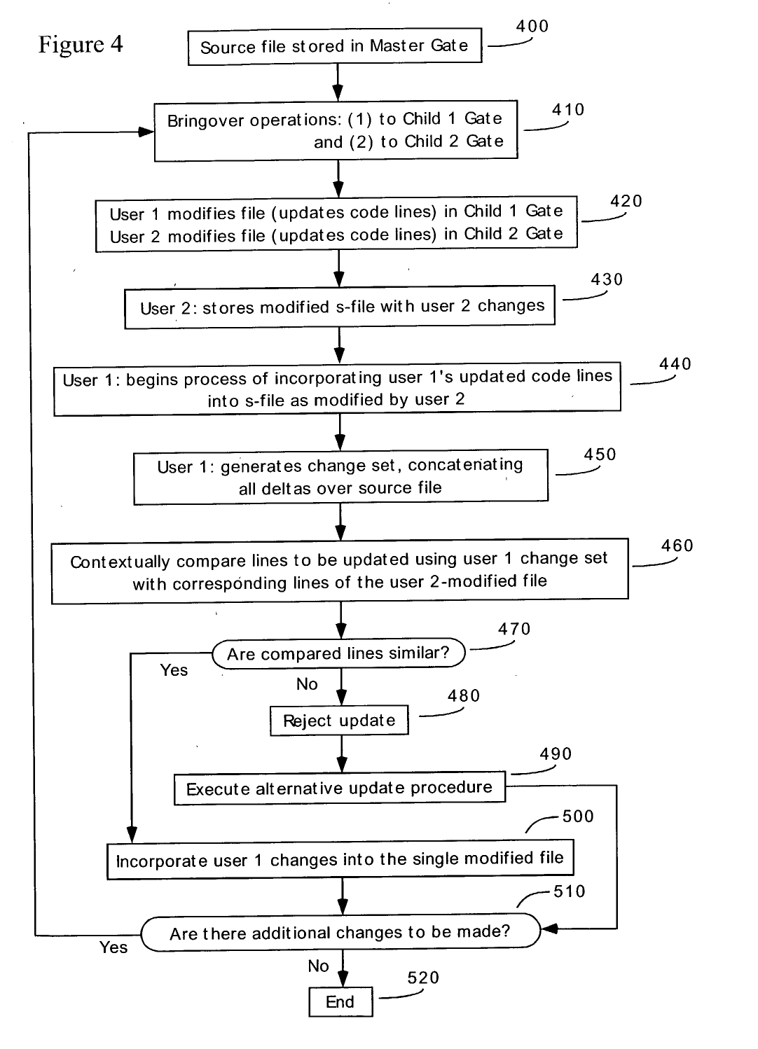

The change set may also be used to replace the conventional putback procedure, since it does not rely upon synchronization of versions to be applied to the source file. Thus, a change set generated based upon user 1's modifications at child 1 gate (290) in FIG. 2 can be used to update the source file in the master gate 280 directly, as well as being used to update other versions of the source file at other workspaces. The procedure of FIG. 4 is thus equally applicable to the source file.

If multiple changes have been made by user 1 to the source file, and the change set is applied to another workspace (e.g. user 2's workspace), then any code that has not been modified in user 2's workspace will be updated with user 1's changes. Thus, user 1 has made ten changes to the source code, and eight of the changes correspond to code that was not changed in user 2's workspace (or other target files), then those eight updates will be made. In the two cases in this example where user 2 has also altered those particular lines of code, step 470 in FIG. 4 will generate a rejection. The reject files provide the user with a history of what was not changed in the update procedure, including the code, the line numbers, and any other information that may be useful in executing an alternative update procedure.

For some applications, it will be desirable to generate update history files reflecting the code contents, line numbers and actions taken when applying a change set from one workspace to another, along with the same information for the reject files. Such history files can be used, for instance, to carry out an “undo” procedure, in case a user should want to undo an update operation at any time. Such an undo procedure can be carried out in essentially the same manner as in FIG. 4, using an “undo” change set instead of the update change set, with substantially opposite effect—i.e., to replace the modified code with the earlier version of the same code.

As indicated above, the procedures according to the invention may be implemented as any combination of software, firmware or hardware desired, and in many different network or processor-based system settings. Generally, an implementation of the invention in a software application (using stored program modules or logic as defined above) that is executable on one or more workstations or servers will be appropriate to a variety of teamware settings.

What is claimed is:

1. A method for updating a source file, including the steps of:
applying a first set of modifications to a first version of the source file to generate a first modified source file;
generating a change set representing the first set of modifications;
comparing portions of the first modified file with the source file to determine whether corresponding portions in the source file have been altered relative to the first version;
for any corresponding portions that have not been altered, then applying the change set to those unaltered portions; and
for any corresponding portions that have been altered, rejecting the change set.

2. The method of claim 1, including, before the comparing step, the additional step of applying a second set of modifications to the source file to generate a second modified source file, such that the comparing step is carried out between the first modified source file and the second modified source file.

3. The method of claim 1, wherein the comparing step includes the steps of:
comparing a first portion at a first location in the first modified file with a second portion at a corresponding location in the source file;
if the compared portions do not match, then comparing the first portion with a third portion of the source file at a location near the corresponding location.

4. The method of claim 3, wherein the third portion is within a predetermined proximity of the corresponding location.

5. The method of claim 4, wherein the step of applying the change set is carried out for any portions for which a match is found within the predetermined proximity of the respective corresponding locations.

6. An update system for updating a second file based upon a first file, wherein the first file and the second file are both based upon a source file, including:
a change set module configured to generate a change set representing at least one modification of the first file with respect to the source file;
a comparison module configured to generate a first comparison of a first portion of the first file containing the modification with a second portion at a corresponding location in the second file;
an update module configured to update the corresponding portion in the second file with the modification if the corresponding portion is found to match the first portion in the first file.

7. The system of claim 6, wherein the second file includes at least one additional modification with respect to the source file.

8. The system of claim 6, wherein the comparison module is further configured to generate a second comparison of the first portion with a third portion at an expanded location near the corresponding location if the first comparison does not result in a match.

9. The system of claim 8, wherein the expanded location includes a location within a predetermined proximity of the corresponding location.

10. The system of claim 6, wherein:
the change set represents a plurality of modifications of the first file with respect to the source file; and
the update module is configured to update the second file with each of the plurality of modifications for which the respective second portions in the second file match the respective first portions in the first file.

11. The system of claim 10, wherein the update module is further configured to leave unaltered any of the respective second portions of the second file whose contents do not match the respective corresponding first portions in the first file.

12. A multi-user file update subsystem of a processor-based system having at least a first storage region and a second storage region, including:
a source file;
a first workspace stored in the first storage region and including a first file having modifications with respect to the source file;
a second workspace stored in the second storage region including a second file having modifications with respect to the source file;
a change set module configured to generate a change set representing at least one modification of the first file with respect to the source file;
a comparison module configured to generate a first comparison of a first portion of the first file containing the modification with a second portion at a corresponding location in the second file;
an update module configured to update the corresponding portion in the second file with the modification if the corresponding portion is found to match the first portion in the first file;

13. The subsystem of claim 12, wherein the comparison module is further configured to generate a second comparison of the first portion with a third portion at an expanded location near the corresponding location if the first comparison does not result in a match.

14. The system of claim 13, wherein the expanded location includes a location within a predetermined proximity of the corresponding location.

15. The system of claim 13, wherein:
the change set represents a plurality of modifications of the first file with respect to the source file; and
the update module is configured to update the second file with each of the plurality of modifications for which the respective second portions in the second file match the respective first portions in the first file.

16. The system of claim 15, wherein the update module is further configured to leave unaltered any of the respective second portions of the second file whose contents do not match the respective corresponding first portions in the first file.

17. A processor-based system, including:
a first workspace configured to provide user access for making first modifications to a source file to generate a first modified version of the source file;
a second workspace configured to provide user access for making second modifications to a source file to generate a second modified version of the source file;
change set logic configured to generate a change set representing the first modifications;
comparison logic configured to compare a first portion of the first modified version of the source file with a corresponding portion of the second modified version of the source file; and
update logic configured to apply the first modifications to the second modified version of the source file if the first portion of the first modified file matches the corresponding portion of the second modified file.

18. The system of claim 17, wherein the comparison logic is further configured to compare the first portion of the first modified version of the source file with an expanded region near the corresponding portion of the second modified version of the source file to locate contents in the second modified version that match corresponding contents in the first modified version.

19. The system of claim 18, wherein the update logic is configured to apply the first modifications to the second modified version of the source file if matching contents are located between the first modified version of the source file and the expanded region in the second modified version of the source file.

20. A method for updating an original source file, including the steps of:
modifying the source file at a first location to generate a first modified version of the source file;
modifying the source file at a second location to generate a second modified version of the source file; and
applying at least a subset of the modifications of the first modified version of the source file to the second modified version of the source file, the subset being applied only to portions of the second modified version of the source file that were not changed relative to the original source file.
